(19) United States
(12) Patent Application Publication
(10) Pub. No.: US 2015/0137441 A1
(43) Pub. Date: May 21, 2015

(54) Quick Bench Vise

(71) Applicant: Ching-Ho Liang, Tainan (TW)

(72) Inventor: Ching-Ho Liang, Tainan (TW)

(21) Appl. No.: 14/085,796

(22) Filed: Nov. 21, 2013

(51) Int. Cl. B25B 1/12

(52) U.S. Cl. CPC B25B 1/125
USPC 269/181

(57) ABSTRACT

A quick bench vise includes a base, a movable jaw, a threaded rod, a sleeve, an adjustment member and a board. The movable jaw has two rods which movably extend through the base. The threaded rod extends through the movable jaw and the base. A collar and a spring are mounted to the threaded rod. The sleeve is located in a chamber of the base and mounted to the threaded rod. The adjustment member is located in a recess of the sleeve and is threadedly connected to the threaded rod. The sleeve has a weight connected thereto and the adjustment member has a curved portion on the outside thereof. The board is connected to the threaded rod and the two rods of the movable jaw. The movable jaw is quickly moved to clamp the workpiece by the sleeve and the adjustment member.

### BACKGROUND OF THE INVENTION

1. Fields of the Invention

The present invention relates to a quick bench vise, and more particularly, to a quick bench vise for quickly clamping a workpiece.

2. Descriptions of Related Art

The conventional vise 1 as shown in FIGS. 1 and 2, and comprises a base 10 with a slide 11 connected thereto. The slide 11 has a slot 110 defined therein. A fixed jaw 12 is connected to the slide 11 and a movable jaw 13 is located corresponding to the fixed jaw 12. The movable jaw 13 has a rail 14 connected to the lower end thereof and the rail 14 extends through the slot 110 of the slide 11. A threaded rod 15 is located in the rail 14 and threadedly extends through a portion of the base 10. A distal end of the threaded rod 15 extends beyond the movable jaw 13 and a bar 16 is connected to the distal end of the threaded rod 15. When using the vise 1, the bar 16 is rotated to rotate the threaded rod 15 to move the movable jaw 14 toward the fixed jaw 12 to hole the workpiece. However, the single rail 14 in the slot 110 is not strong enough so that the workpiece is not firmly clamped and may shake. Besides, when clamping a smaller workpiece, the threaded rod 15 has to be rotated many revolutions to move the movable jaw 13 to desired position, and this takes a lot of time. On the contrary, when the workpiece is long, the threaded rod 15 needs to be reverted to yield the space between the fixed and movable jaws 12, 13 for clamping the workpiece between the fixed and movable jaws 12, 13, and then the threaded rod 15 is rotated to allow the movable jaw 13 firmly contact the workpiece. It still a time-consuming task, and when the threaded rod 15 is moved backward too much, the workpiece cannot be well clamped and may even drop or shake during machining. Furthermore, the user's fingers may be injured by the fixed and movable jaws 12, 13 if he or she operates the vise 1 improperly.

The present invention intends to provide a quick bench vise to improve the shortcomings mentioned above.

### SUMMARY OF THE INVENTION

The present invention relates to a quick bench vise and comprises a base having a chamber defined therein, and a guide member and two stops are located on the inside of the chamber. A passage is defined through the front wall and the rear wall of the base, and communicates with the chamber. A fixed jaw is connected to the base. At least two through holes are defined through the front and rear walls of the base.

A movable jaw has a hole and at least two rods extend from the movable jaw. The at least two rods extend through the at least two through holes of the base. A threaded rod extends through the hole of the movable jaw, the passage of the base and the chamber. The threaded rod has outer threads, and a bar is connected to the first end of the threaded rod and a positioning end extends from the second end of the threaded rod.

A collar is mounted to the threaded rod and is located between the movable jaw and the base. The collar has a threaded hole defined through the wall thereof and a first bolt extends through the threaded hole of the collar to position the collar to the threaded rod. A spring is mounted to the threaded rod and located between the collar and the base.

A sleeve is located in the chamber and mounted to the threaded rod. The sleeve has a passage defined axially therethrough. A recess is defined in the outside of the sleeve and two slots are respectively defined in two end faces of the sleeve. A weight is connected to the outside of the sleeve. An adjustment member is engaged with the recess of the sleeve and has inner threads defined therein. Two extensions respective extend from two ends of the adjustment member and are engaged with the slots of the sleeve. The extensions are stopped by the stops of the base. The adjustment member has a curved portion on the outside thereof and the curved portion is located beside the guide member of the base. A board has a positioning hole through which the positioning end of the threaded rod extends. The board is connected to two distal ends of the two rods.

Preferably, the base has notches defined in two ends and the rear side thereof.

Preferably, two protrusions extend from the front side of the base.

Preferably, the base has threaded holes defined in the top thereof. A cover is mounted to the rear side of the base and the board. The cover has holes and third bolts extend through the holes of the cover and are connected with the threaded holes of the base.

Preferably, each of the at least two rods of the movable jaw has a threaded hole defined in the distal end thereof. The board has at least two holes, and two second bolts extend through the at least two holes of the board and are connected to the threaded holes of the at least two rods to fix the board to the distal ends of the at least two rods.

The primary object of the present invention is to provide a quick bench vise wherein the movable jaw is quickly moved to clamp the workpiece between the movable and fixed jaws. The workpiece is firmly positioned and the user's fingers are protected from being injured by the movable and fixed jaws.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the conventional vise;

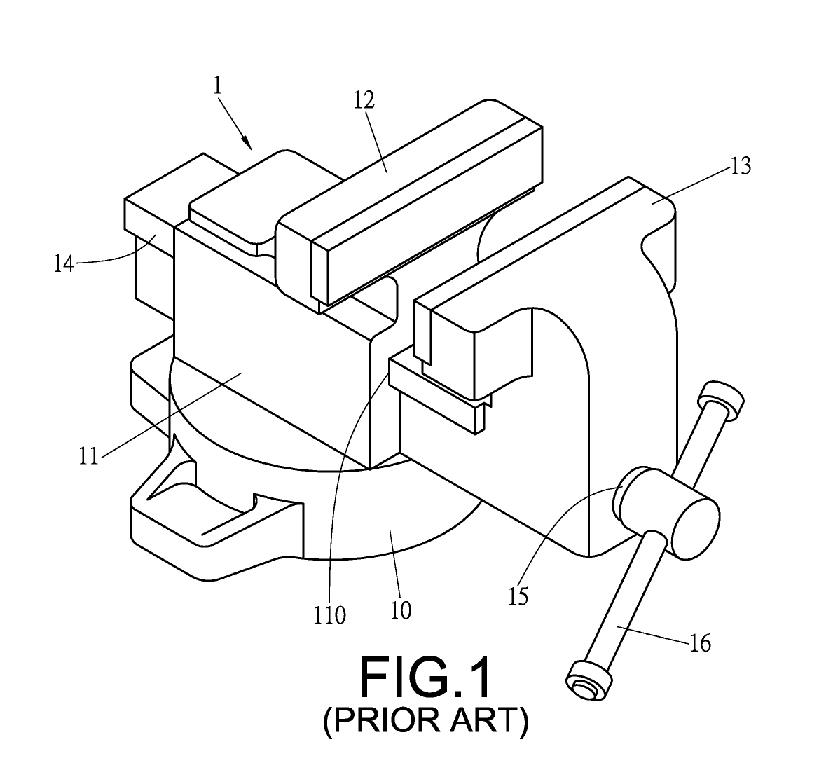

FIG. 2 is a cross sectional view of the conventional vise;

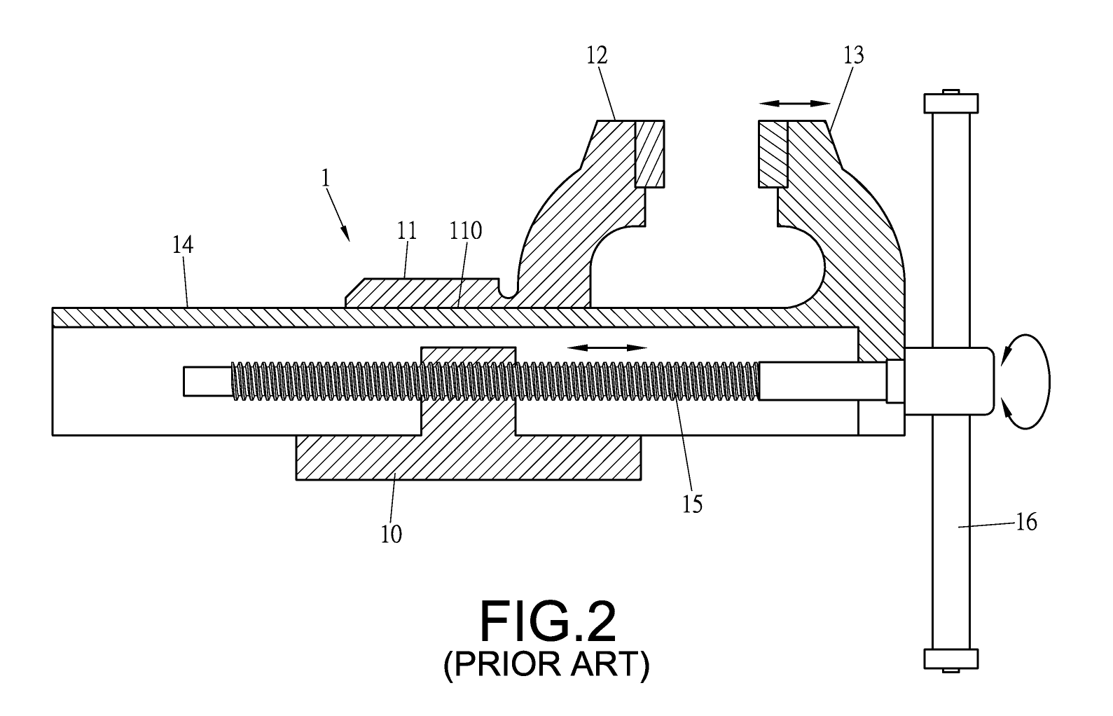

FIG. 3 is an exploded view of the quick bench vise of the present invention;

FIG. 4 is another exploded view of the quick bench vise of the present invention;

FIG. 5 is a perspective view to show the quick bench vise of the present invention;

FIG. 6 is a cross sectional view of the quick bench vise of the present invention;

FIG. 7 is a cross sectional view, taken along line A-A in FIG. 6;

FIG. 8 shows that the movable jaw moves away from the fixed jaw, and

FIG. 9 is a cross sectional view, taken along line B-B in FIG. 8.

### DETAILED DESCRIPTION OF THE PREFERRED EMBODIMENT

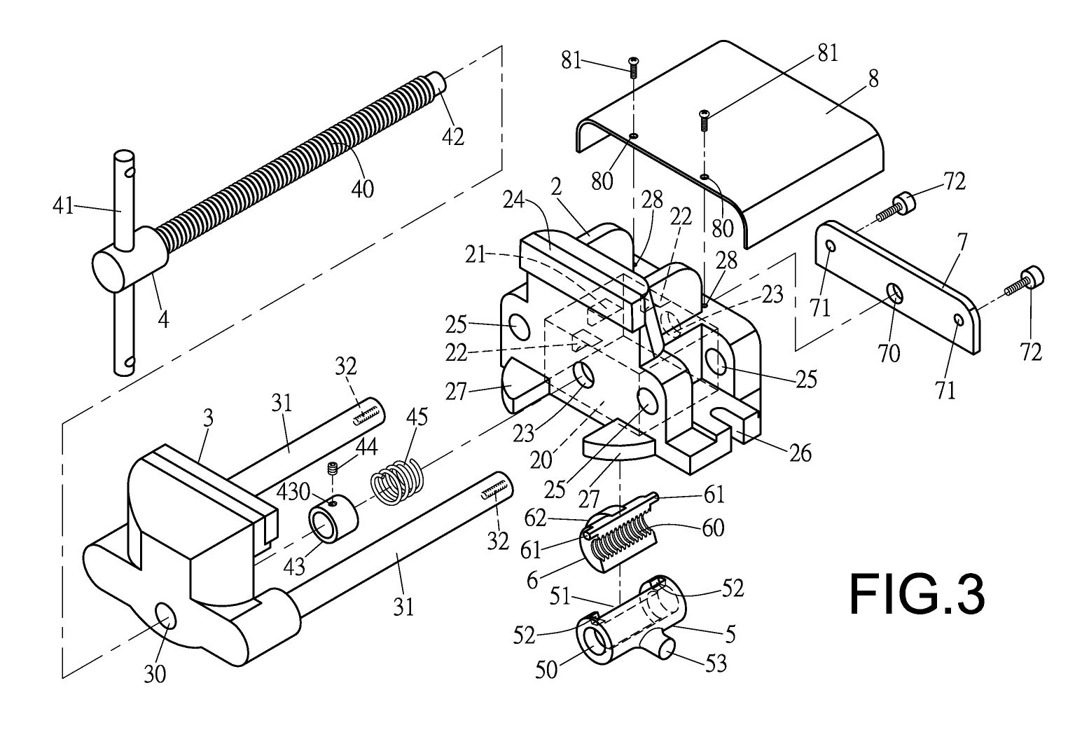

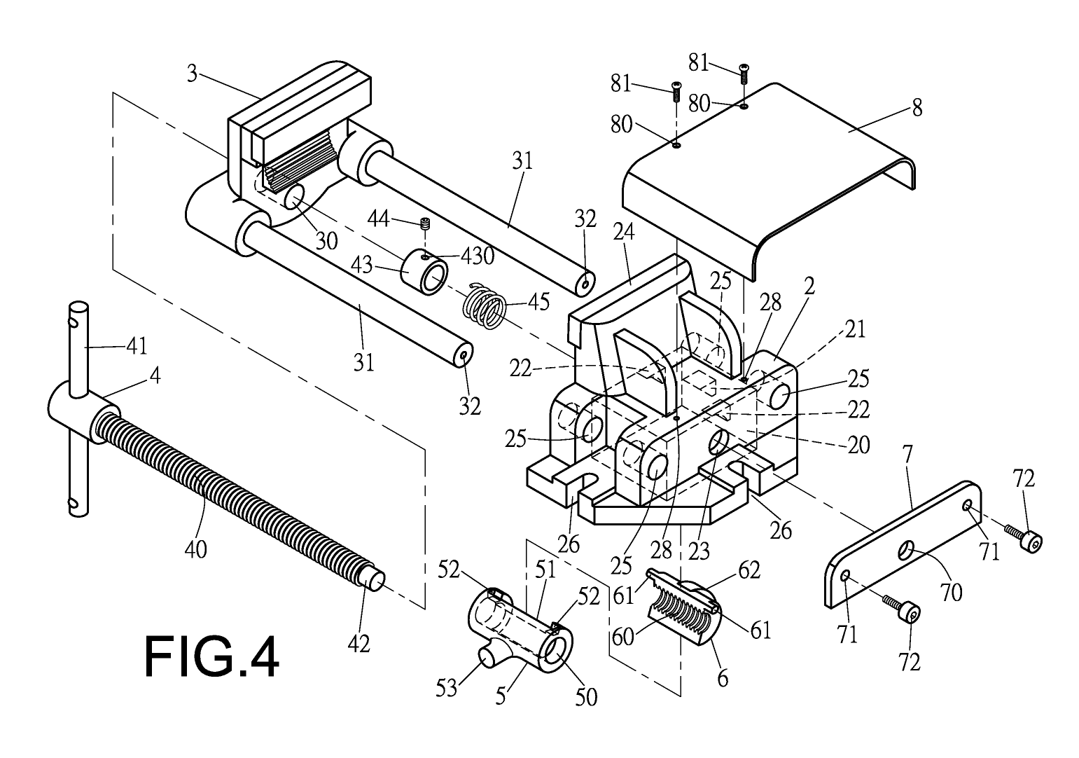

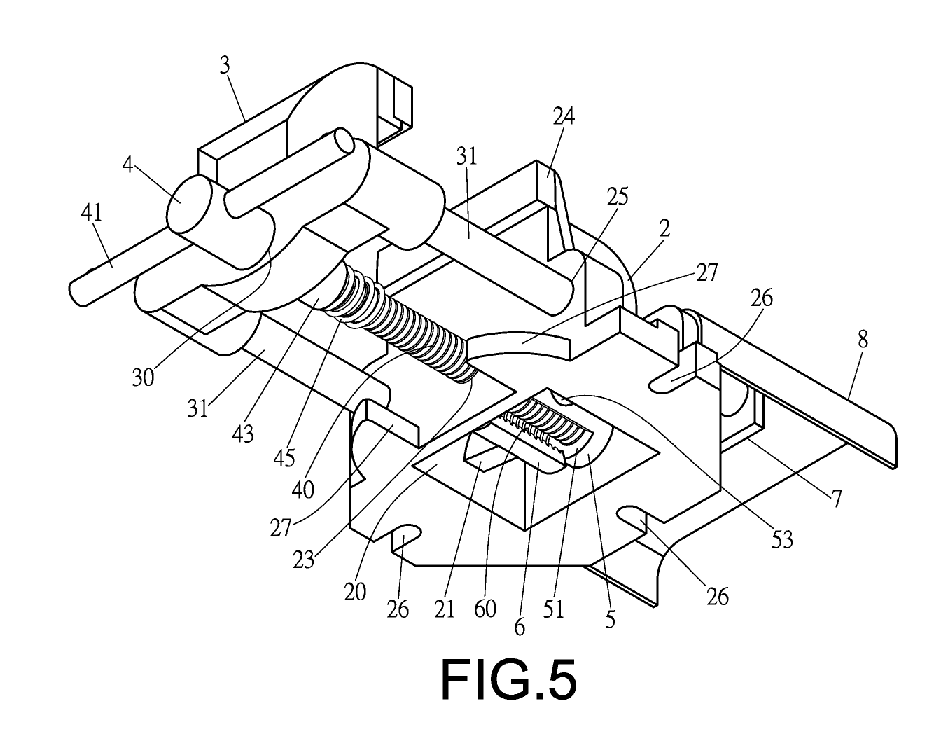

Referring to FIGS. 3 to 5, the quick bench vise of the present invention comprises a base 2 having a chamber 20, and a guide member 21 and two stops 22 are located on the inside of the chamber 20. A passage 23 is defined through the front wall and the rear wall of the base 2 and communicates with the chamber 20. A fixed jaw 24 is connected to the base 2 and two through holes 25 are defined through the front and rear walls of the base 2. The base 2 has notches 26 defined in two ends and the rear side thereof. Two protrusions 27 extend from the front side of the base 2. The base 2 has threaded holes 28 defined in the top thereof.

A movable jaw 3 has a hole 30 and two rods 31 extend from the movable jaw 3. The two rods 31 extend through the two through holes 25 of the base 2. Each of the two rods 31 of the movable jaw 3 has a threaded hole 32 defined in the distal end thereof.

A threaded rod 4 extends through the hole 30 of the movable jaw 3, the passage 23 of the base 2 and the chamber 20. The threaded rod 4 has outer threads 40. A bar 41 is connected to the first end of the threaded rod 4 and a positioning end 42 extends axially from the second end of the threaded rod 4. A collar 43 is mounted to the threaded rod 4 and located between the movable jaw 3 and the base 2. The collar 43 has a threaded hole 430 defined through the wall thereof and a first bolt 44 extends through the threaded hole 430 of the collar 43 to position the collar 43 to the threaded rod 4. A spring 45 is mounted to the threaded rod 4 and located between the collar 43 and the base 2.

A sleeve 5 is located in the chamber 20 and mounted to the threaded rod 4. The sleeve 5 has a passage 50 defined axially therethrough, and a recess 51 is defined in the outside of the sleeve 5. Two slots 52 are respectively defined in two end faces of the sleeve 5. A weight 53 is connected to the outside of the sleeve 5.

An adjustment member 6 is engaged with the recess 51 of the sleeve 5 and has inner threads 60 defined therein which are located corresponding to the outer threads 40 of the threaded rod 4. Two extensions 61 respective extend from two ends of the adjustment member 6 and are engaged with the slots 52 of the sleeve 5. The extensions 61 are stopped by the stops 22 of the base 2. The adjustment member 6 has a curved portion 62 on the outside thereof and the curved portion 62 is located beside the guide member 21 of the base 2.

A board 7 has a positioning hole 70 through which the positioning end 42 of the threaded rod 4 extends. The board 7 has two holes 71 and two second bolts 72 extend through the two holes 71 and are connected to the threaded holes 32 in the two distal ends of the two rods 31 of the movable jaw 3. A cover 8 is mounted to the rear side of the base 2 and the board 7. The cover 8 has holes 80 and the third bolts 81 extend through the holes 80 of the cover 8 and are connected with the threaded holes 28 of the base 2.

When in assembling, further referring to FIGS. 3 to 6, the threaded rod 4 extends through the hole 30 of the movable jaw 3 and the collar 43 is connected to the outer threads 40 of the threaded rod 4. One side of the collar 43 contacts the inside of the movable jaw 3, and the first bolt 44 is tightened to the collar 43 to fix the collar 43 to the threaded rod 4. The spring 45 is mounted to the outer threads 40 of the threaded rod 4. The adjustment member 6 is connected to the recess 51 of the sleeve 5, and the two extensions 61 are engaged with the two slots 52 of the sleeve 5. The adjustment member 6 and the sleeve 5 are both located in the chamber 20 of the base 2. The two extensions 61 are stopped by the two stops 22. The curved portion 62 of the adjustment member 6 contacts the guide member 21 in the chamber 20 of the base 2. The movable jaw 3 and the threaded rod 4 are installed to the base 2. The two rods 31 of the movable jaw 3 extend through the two through holes 25 of the base 2 and beyond the rear side of the base 2. The threaded rod 4 extend through the passage 23 of the base 2 and the chamber 20. The threaded rod 4 extends through the passage 50 of the sleeve 5. The inner threads 60 of the adjustment member 6 are engaged with the outer threads 40 of the threaded rod 4. The sleeve 5 is rotated downward by the weight 53 due to gravity. The threaded rod 4 extends beyond the rear wall of the base 2. The board 7 is connected to the threaded rod 4 and the two rods 31 of the movable jaw 3. The positioning end 42 of the threaded rod 4 is engaged with the positioning hole 70 of the board 7. The two second bolts 72 extend through the two holes 71 and are connected to the threaded holes 32 in the two distal ends of the two rods 31 of the movable jaw 3. Therefore, the board 7 is connected to the threaded rod 4 and the two rods 31 of the movable jaw 3. The cover 8 is mounted to the rear side of the base 2 and the board 7. The holes 80 of the cover 8 are located corresponding to the threaded holes 28 of the base 2. The third bolts 81 extend through the holes 80 of the cover 8 and are connected with the threaded holes 28 of the base 2.

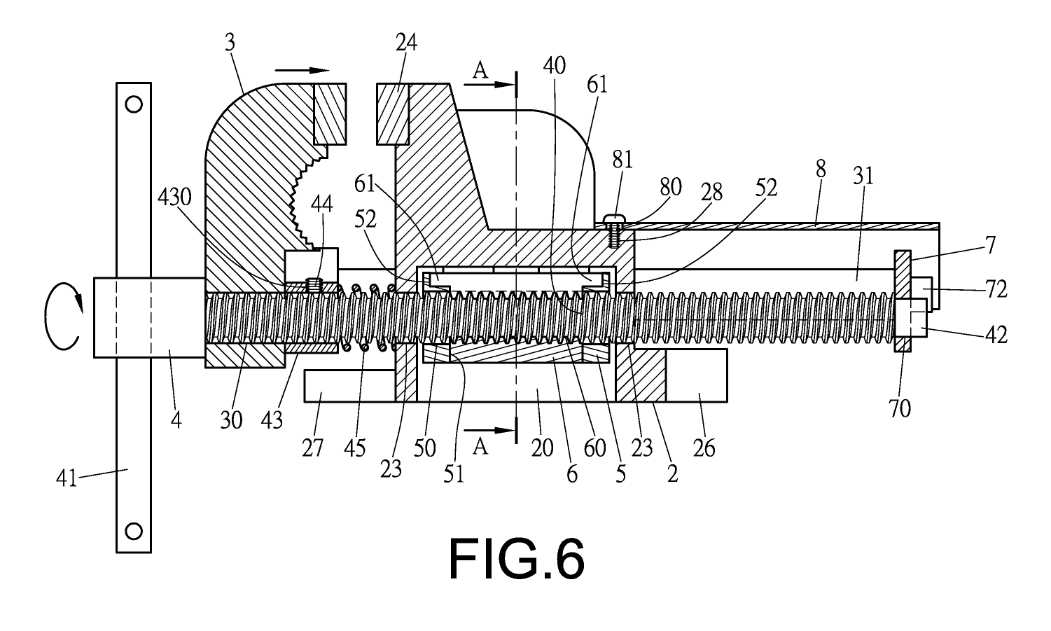

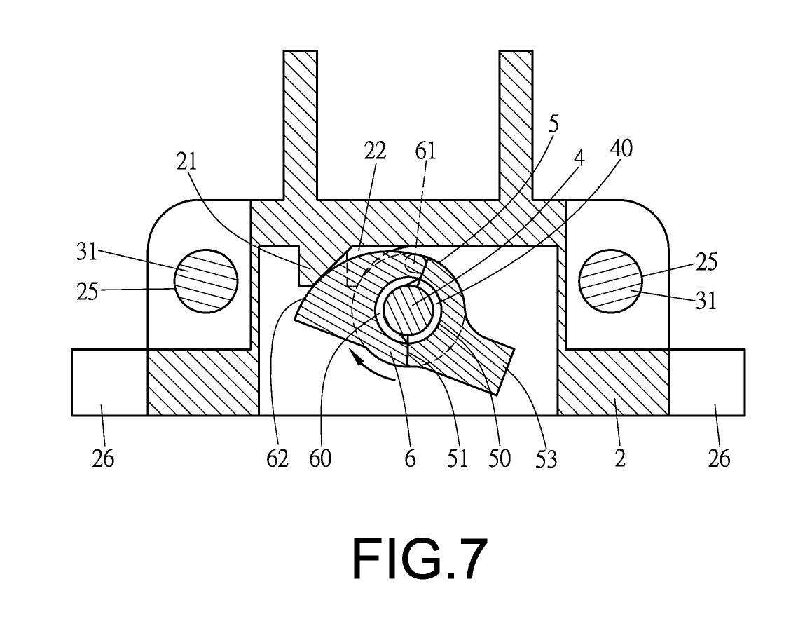

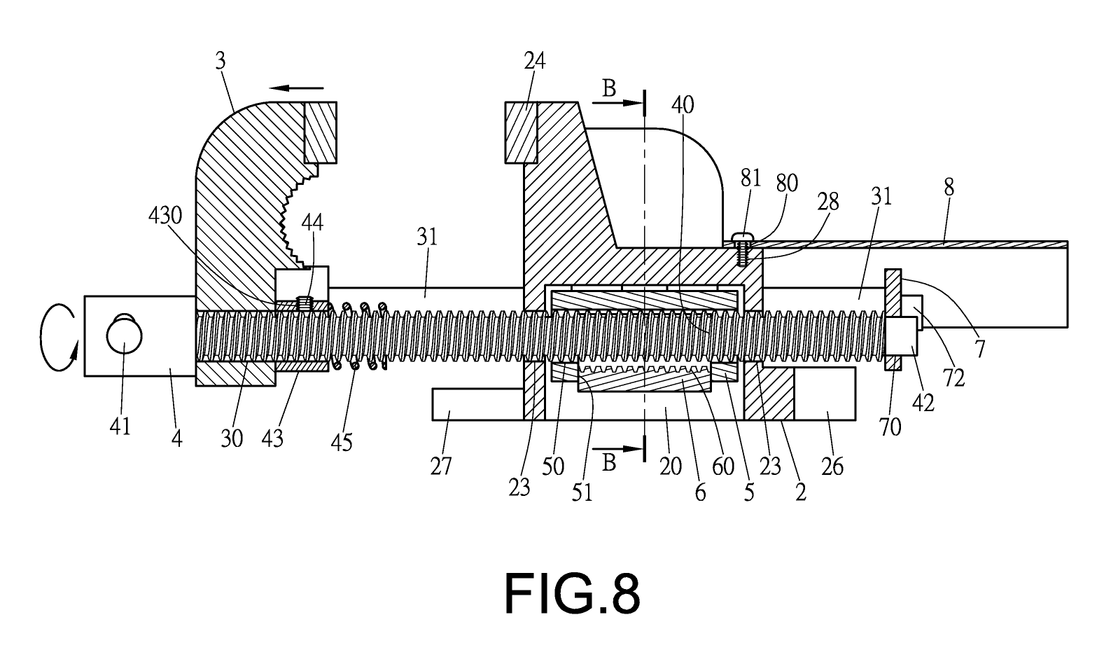

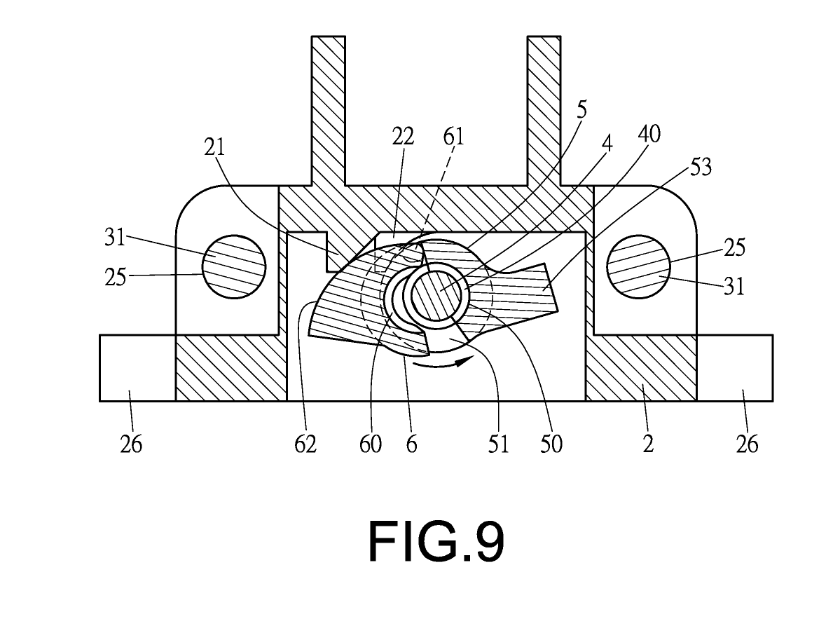

As shown in FIGS. 6 to 9, the base 2 is connected to a wok bench (not shown) by using bolts through the notches 26 of the base 2 and connected to the work bench. When adjusting the distance between the movable jaw 3 and the fixed jaw 24, the user holds the bar 41 and rotates the bar 41 counter clockwise to rotate the threaded rod 4 to rotate counter clockwise as shown in FIGS. 8 and 9. The adjustment member 6 is driven by the threaded rod 4 and the curved portion 62 of the adjustment member 6 moves outward along the guide member 21 of the base 2. The sleeve 5 is moved upward due to the operation of the adjustment member 6. An opening is formed between the lower end of the adjustment member 6 and the sleeve 5 by the weight of the curved portion 62 as shown in FIG. 9. The inner threads 60 of the adjustment member 6 are not engaged with the outer threads 40 of the threaded rod 4, the threaded rod 4 can be moved outward. The movable jaw 3 is able to be moved outward with the threaded rod 4 so that the distance between the movable jaw 3 and the fixed jaw 24 is increased. The weight 53 of the sleeve 5 is rotated downward due to gravity so as to rotate the adjustment member 6 upward and back to its initial position. The adjustment member 6 is then connected to the sleeve 5 again as shown in FIG. 7.

The inner threads 60 of the adjustment member 6 are engaged with the outer threads 40 of the threaded rod 4. The curved portion 62 of the adjustment member 6 is stopped by the guide member 21 in the chamber 20. The adjustment member 6 does not pivoted outward. The threaded rod 4 is then rotated clockwise as shown in FIGS. 6 and 7, the threaded rod 4 moves inward relative to the inner threads 60 of the adjustment member 6 to adjust the relative distance between the movable jaw 3 and the fixed jaw 24 to firmly clamp the workpiece.

Therefore, the threaded rod 4 is needed to be rotated slightly to disengage the inner threads 60 of the adjustment member 6 from the outer threads 40 of the threaded rod 4. The movable jaw 3 and the threaded rod 4 can be quickly moved. The user does not need to rotate the threaded rod 4 slowly as the conventional vise does. When the movable jaw 3 is moved to a proper position relative to the fixed jaw 24, the threaded rod 4 is then rotated clockwise to engage the inner threads 60 of the adjustment member 6 with the outer threads 40 of the threaded rod 4. The threaded rod 4 is rotatably moved relative to the adjustment member 6 and the sleeve 5. The movable jaw 3 is moved toward the fixed jaw 24 to firmly clamp the workpiece. The movable jaw 3 is stably moved by the guidance of the two rods 31 so that the workpiece can be firmly clamped.

The threaded rod 4 is cooperated with the spring 45 which keeps the movable jaw 3 located at a proper distance from the fixed jaw 24 so that the user's fingers do not clamped and injured when the fingers are unintentionally inserted between the movable jaw 3 and the fixed jaw 24. The board 7 is connected to the threaded rod 4 and the two rods 31 to prevent the movable jaw 3 and the threaded rod 4 from being pulled out from the vise. The cover 8 prevent the users' finger from being pinched by the board 7.

While we have shown and described the embodiment in accordance with the present invention, it should be clear to those skilled in the art that further embodiments may be made without departing from the scope of the present invention.

What is claimed is:

1. A quick bench vise comprising:
a base having a chamber, a guide member and two stops located on an inside of the chamber, a passage defined through a front wall and a rear wall of the base and communicating with the chamber, a fixed jaw connected to the base, at least two through holes defined through the front and rear walls of the base;
a movable jaw having a hole and at least two rods extending from the movable jaw, the at least two rods extending through the at least two through holes of the base;
a threaded rod extending through the hole of the movable jaw, the passage of the base and the chamber, the threaded rod having outer threads, a bar connected to a first end of the threaded rod and a positioning end extending from a second end of the threaded rod, a collar mounted to the threaded rod and located between the movable jaw and the base, the collar having a threaded hole defined through a wall thereof and a first bolt extending through the threaded hole of the collar to position the collar to the threaded rod, a spring mounted to the threaded rod and located between the collar and the base;
a sleeve located in the chamber and mounted to the threaded rod, the sleeve having a passage defined axially therethrough, a recess defined in an outside of the sleeve and two slots respectively defined in two end faces of the sleeve, a weight connected to the outside of the sleeve;
an adjustment member engaged with the recess of the sleeve and having inner threads defined therein, two extensions respective extending from two ends of the adjustment member and engaged with the slots of the sleeve, the extensions being stopped by the stops of the base, the adjustment member having a curved portion on an outside thereof and the curved portion located beside the guide member of the base, and
a board having a positioning hole through which the positioning end of the threaded rod extends, the board connected to two distal ends of the two rods.

2. The quick bench vise as claimed in claim 1, wherein the base has notches defined in two ends and a rear side thereof.

3. The quick bench vise as claimed in claim 1, wherein two protrusions extend from a front side of the base.

4. The quick bench vise as claimed in claim 1, wherein the base has threaded holes defined in a top thereof, a cover is mounted to a rear side of the base and the board, the cover has holes and third bolts extend through the holes of the cover and are connected with the threaded holes of the base.

5. The quick bench vise as claimed in claim 1, wherein each of the at least two rods of the movable jaw has a threaded hole defined in a distal end thereof, the board has at least two holes, two second bolts extend through the at least two holes of the board and are connected to the threaded holes of the at least two rods to fix the board to the distal ends of the at least two rods.
